(19) United States
(12) Patent Application Publication
(10) Pub. No.: US 2026/0019198 A1
(43) Pub. Date: Jan. 15, 2026

(54) HARD-ACK BUNDLING HANDLING ENABLING AND DISABLING OF HARQ FEEDBACK IN IOT-NTN SCENARIOS

(71) Applicant: Telefonaktiebolaget LM Ericsson (publ), Stockholm (SE)

(72) Inventors: Gerardo Agni MEDINA ACOSTA, Märsta (SE); Chunhui LI, Kanagawa (JP)

(21) Appl. No.: 18/994,307

(22) PCT Filed: Jun. 7, 2023
(86) PCT No.: PCT/SE2023/050568

§ 371 Date: Jan. 14, 2025

Related U.S. Application Data
(60) Provisional application No. 63/393,192, filed on Jul. 28, 2022.

(51) Int. Cl. H04L 1/1829; H04L 1/1812

(52) U.S. Cl. CPC H04L 1/1864; H04L 1/1812

(57) ABSTRACT

A wireless device configured to communicate with a network node via a non-terrestrial network, NTN, is provided. The wireless device is configured to obtain an indication to disable at least one hybrid automatic repeat request, HARQ, process and to enable at least one other HARQ process. The wireless device further receives a downlink control information transmission and its corresponding physical downlink shared channel transmission for the at least one disabled HARQ process and receives a downlink control information transmission and its corresponding physical downlink shared channel transmission for the at least one enabled HARQ process. The wireless device transmits a HARQ-acknowledgement transmission, wherein the HARQ-acknowledgement transmission is based on a respective HARQ-acknowledgement bit for the at least one disabled HARQ process and the at least one enabled HARQ process. Corresponding methods and systems are also disclosed.

### TECHNICAL FIELD

The present disclosure relates to wireless communications, and in particular, to disabling at least one hybrid automatic repeat request (HARQ) process in, for example, internet of things-non-terrestrial network (IoT-NTN).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

During the Radio Access Network (RAN) plenary meeting #94-e, a new Work Item (WI) entitled “New WID on IoT NTN enhancements” was discussed. According to the Work Item Description (WID), one of the objectives includes:
Disabling of HARQ feedback to mitigate impact of HARQ stalling on wireless device data rates [RAN1,RAN2].

One reason for considering disabling the HARQ feedback for IoT-NTN is the large roundtrip delay between the wireless device and the network node. Table 2 below shows both the delay and doppler shift values for various satellite orbits.

TABLE 2
Delay and Doppler shift values for various satellite orbits.

| | LEO | | | | GEO | |
|---|---|---|---|---|---|---|
| Orbit altitude | 600 | km | 1200 | km | 35.786 | km |
| Distance at | 1932 | km | 3131 | km | 40.581 | km |
| minimum elevation | | | | | | |
| Delay at maximum | 8.0 | ms | 16.0 | ms | 477 | ms |
| elevation | | | | | | |
| Delay at minimum | 25.8 | ms | 41.8 | ms | 541 | ms |
| elevation | | | | | | |
| Maximum Doppler | 24 | ppm | 21 | ppm | <1 | ppm |
| shift | | | | | | |
| Maximum Doppler | 0.27 | ppm/s | 0.13 | ppm/s | ~0 | ppm/s |
| shift variation | | | | | | |

Although the large roundtrip delays between wireless device and network node can, in principle, suggest that in IoT NTN the HARQ feedback may be disabled, using existing functionalities embedded into the LTE-Machine Type Communication (MTC) and Narrowband IoT (NB-IoT) features makes it possible to obtain non-negligible data rates (i.e., in the order of hundreds of kbps) in some scenarios.

In one scenario, “ce-PDSCH-14HARQ-Config-r17” was used along with HARQ-Acknowledgement (ACK) bundling to alleviate the HARQ stalling issue. Below is discussion of 3GPP Technical Specification (TS) 36.213 clause 7.3.1 referring to “ce-PDSCH-14HARQ-Config-r17” when configured and not configured along with HARQ-ACK bundling.

### 3GPP TS 36.213 Clause 7.3.1 Discussion

For a BL/CE wireless device with higher layer parameter ce-PDSCH-14HARQ-Config not configured, for PDSCH transmission in subframe n−k−K_{offset}, if the wireless device is in half-duplex FDD operation and is configured with CEModeA and higher layer parameter ce-HARQ-AckBundling and the ‘HARQ-ACK bundling flag’ in the corresponding DCI is set to 1, or if the wireless device is configured with higher layer parameter ce-SchedulingEnhancement,
if the ‘HARQ-ACK delay’ field in the corresponding DCI indicates value k, the wireless device determines the subframe n as the HARQ-ACK transmission subframe
the HARQ-ACK delay value k is determined from the corresponding DCI based on the higher layer parameters according to Table 7.3.1-2 of 3GPP TS 36.213 clause 7.3.1.
   For a BL/CE wireless device with higher layer parameter ce-PDSCH-14HARQ-Config configured, for PDSCH transmission in subframe n−k, if the wireless device is in half-duplex FDD operation and is configured with CEModeA, and ‘PDSCH scheduling delay and HARQ-ACK delay for 14 HARQ’ field is present in the corresponding DCI,
if the HARQ-ACK delay value as defined in 3GPP 36.213, version 17.0.0, in the corresponding DCI indicates value k, the wireless device determines the subframe n as the HARQ-ACK transmission subframe.
   For a BL/CE wireless device in half-duplex FDD operation, if the wireless device is configured with CEModeA, and if the wireless device is configured with higher layer parameter ce-HARQ-AckBundling and the ‘HARQ-ACK bundling flag’ in the corresponding DCI is set to 1,
for HARQ-ACK transmission in subframe n, the wireless device generates one HARQ-ACK bit by performing a logical AND operation of HARQ-ACKs across all 1≤M≤4 BL/CE DL subframes for which subframe n is the ‘HARQ-ACK transmission subframe’.
if subframe n−k₁ is the most recent subframe for which subframe n is the ‘HARQ-ACK transmission subframe’, and if the ‘Transport blocks in a bundle’ field in the corresponding DCI for PDSCH transmission in subframe n−k₁ indicates a number of transport blocks in a bundle other than M, the wireless device generates a NACK for HARQ-ACK transmission in subframe n.
if the wireless device has received W PDSCH transmissions before subframe n, and if the wireless device is expected to transmit HARQ-ACK for the W PDSCH transmissions in subframes {n₁ . . . n_{L}}, nᵢ≥n, the wireless device is not expected to receive a new PDSCH transmission in subframe n, where W=10 if higher layer parameter ce-pdsch-tenProcesses-config is set to ‘On’, W=12 if higher layer parameter ce-PDSCH-14HARQ-Config is configured, and W=8 otherwise.
if the wireless device is expected to transmit HARQ-ACK for the PDSCH transmissions received before subframe n in subframes {n₁, n₂, n₃}, nᵢ≥n, the wireless device is not expected to receive a new PDSCH transmission in subframe n for which the HARQ-ACK is to be transmitted in subframe n₄∉{n₁, n₂, n₃}.

TABLE 7.3.1-2
HARQ-ACK delay for BL/CE UE in CEModeA

| | | HARQ-ACK delay value |
|---|---|---|
| | | when ‘ce- |
| | | SchedulingEnhancement’ |
| | | set to ‘range2’, or ‘ce- |
| | HARQ-ACK delay value | SchedulingEnhancement’ |
| ‘HARQ-ACK | when ‘ce- | is not configured and |
| delay’ field in | SchedulingEnhancement’ | ‘ce-HARQ-AckBundling’ |
| DCI | set to ‘range1’ | is set |
| 000 | 4 | 4 |
| 001 | 5 | 5 |
| 010 | 7 | 6 |
| 011 | 9 | 7 |
| 100 | 11 | 8 |
| 101 | 13 | 9 |
| 110 | 15 | 10 |
| 111 | 17 | 11 |

FIG. 1 is an example of LTE-MTC Table A1 that illustrates the framework of “ce-PDSCH-14HARQ-Config-r17” used along with HARQ-ACK bundling, which in 3GPP Release 17 (Rel-17) introduced the possibility of using up to 14 HARQ processes in downlink for Half Duplex-Frequency Division Duplexing (HD-FDD) Cat M1 wireless devices.

FIG. 2 is an example of time progression of Table A1. The dashed and dotted arrows illustrate examples of the “PDSCH scheduling delay” (encompassing 7 subframes) and “HARQ-ACK delay” (encompassing 13 subframes), respectively.

In Table A1, MPDCCH#0 and PDSCH#0 refer to the control channel and corresponding user data associated to HARQ Process #0. PUCCH #0 in Subframe #13 bundles four ACKs/NACKs associated to multiple HARQ processes (see numbers surrounded by brackets). Other HARQ processes depicted in Table 1 follow the same logic and terminology respectively.

Assuming the transmission of transport blocks of 1000 bits, a peak data rate of around 706 kbps can be achieved. Moreover, in Rel-17, a new maximum downlink TBS of 1736 bits was introduced which with the same framework allows achieving a peak data rate around 1.22 Mbps.

On the other hand, Table A1.2, illustrated in FIG. 3, refers to the framework of the “ce-PDSCH-14HARQ-Config-r17” feature in an NTN scenario considering a Low Earth orbit (LEO) satellite at an orbit altitude of 600 km. The framework in Table A1.2 used 10 HARQ processes for NTN LTE-MTC upon incorporating the propagation delay encompassing both the delay in the downlink (DL) direction and the way-back in the uplink (UL) direction. FIG. 4 is an example of time progression of Table A1.2.

Based on the framework depicted in Table A1.2, assuming a Transport Block Size (TBS) of 1000 bits the resulting peak data rate equals (1000*10)/41˜243 kbps. On the other hand, when the new maximum DL TBS of 1736 bits introduced in Rel-17 is assumed, the resulting peak data rate is ˜ 423 kbps.

In RAN1 #109-e, the Rel-18 objective on “Disabling of HARQ feedback to mitigate impact of HARQ stalling on UE data rates” was started and the following agreements were reached. Both enabling and disabling of HARQ feedback were considered in the agreements:

### Agreement

For IoT NTN, to configure/indicate enabling/disabling on HARQ feedback for downlink transmission, one or more of the following options can be considered:
Option 1: per HARQ process via UE specific RRC signaling
Option 2: per HARQ process via SIB signaling
Option 3: explicitly indicated by DCI (e.g., new field or reusing existing field)
Option 4: implicitly determined by existing configured/indicated parameter(s) (e.g., repetition number, TBS)
Option 5: per HARQ process via MAC CE
Other options or combinations are not excluded
   Note: Option(s) for eMTC and NBIoT can be separately discussed

### Agreement

For IoT NTN, further study the potential issues due to enabling/disabling on HARQ feedback for downlink transmission
Issue A: SPS PDSCH
Issue B: (N) PDSCH/(N) PDCCH scheduling restriction
Issue C: HARQ feedback for scheduling multiple TB
Issue D: HARQ bundling for eMTC HD-FDD
Issue F: NPRACH capacity
Issue G: Serving cell/satellite change during data transfer (FFS: for eMTC and/or NB-IoT)
Other issues are not excluded
   Note: The “Issues” in common for eMTC and NB-IoT can be separately discussed.

### SUMMARY

While Rel-18 proposes the possibility of enabling and disabling HARQ feedback, there are not existing methods that provide how disabling of HARQ feedback can be accomplished and during which scenarios. Therefore, certain aspects of the disclosure and the embodiments may provide solutions to how to accomplish disabling of HARQ feedback and during which scenarios.

Some embodiments advantageously provide methods, systems, and apparatuses for disabling at least one HARQ process in, for example, internet of things-non-terrestrial network (IoT-NTN).

The 3GPP Rel-18 objective on “Disabling HARQ feedback” for IoT-NTN has considered the possibility of enabling and disabling HARQ feedback, thus one or more embodiments described herein provide for the “HARQ-ACK bundling” to handle a scenario where all HARQ processes have been disabled, and a hybrid scenario where one or more of the HARQ processes have the HARQ feedback disabled, whereas the rest of the HARQ processes keep their HARQ feedback enabled.

A first aspect of the invention provides a method implemented by a wireless device that is configured to communicate with a network node via a non-terrestrial network, NTN. The method comprises obtaining an indication to disable at least one hybrid automatic repeat request, HARQ, process and to enable at least one other HARQ process. The method further comprises receiving a downlink control information transmission and its corresponding physical downlink shared channel transmission for the at least one disabled HARQ process and receiving a downlink control information transmission and its corresponding physical downlink shared channel transmission for the at least one enabled HARQ process. The downlink control information transmissions for the at least one disabled HARQ process and the at least one enabled HARQ process indicate a same subframe where a HARQ-acknowledgement transmission is to be transmitted. The method further comprises transmitting the HARQ-acknowledgement transmission in the indicated subframe, wherein the HARQ-acknowledgement transmission is based on a respective HARQ-acknowledgement bit for the at least one disabled HARQ process and the at least one enabled HARQ process. An acknowledgment bit is generated as HARQ-acknowledgement bit for the enabled at least one HARQ process if the physical downlink shared channel transmission for the at least one enabled HARQ process was successfully decoded, and a non-acknowledgment bit otherwise. An acknowledgment bit is generated as HARQ-acknowledgement bit for the disabled at least one HARQ process regardless of whether the physical downlink shared channel transmission for the at least one disabled HARQ process was successfully decoded or not.

A second aspect of the invention provides a method implemented in a network node that is configured to communicate with a wireless device via a non-terrestrial network, NTN. The method comprises determining to disable at least one hybrid automatic repeat request, HARQ, process and to enable at least one other HARQ process and signaling an indication that is configured to disable the at least one HARQ process and to enable the at least one other HARQ process at the wireless device. The method further comprises transmitting a downlink control information transmission and its corresponding physical downlink shared channel transmission for the at least one disabled HARQ process and transmitting a downlink control information transmission and its corresponding physical downlink shared channel transmission for the at least one enabled HARQ process. The downlink control information transmissions for the at least one disabled HARQ process and the at least one enabled HARQ process indicate a same subframe where a HARQ-acknowledgement transmission is to be transmitted. The method further comprises receiving the HARQ-acknowledgement transmission in the indicated subframe. The HARQ-acknowledgement transmission is based on a respective HARQ-acknowledgement bit for the at least one disabled HARQ process and the at least one enabled HARQ process.

A third aspect of the invention provides a wireless device configured to communicate with a network node via a non-terrestrial network, NTN. The wireless device configured to, and/or comprising a radio interface and/or processing circuitry configured to obtain an indication to disable at least one hybrid automatic repeat request, HARQ, process and to enable at least one HARQ process. The wireless device and/or radio interface and/or processing circuitry is further configured to receive a downlink control information transmission and its corresponding physical downlink shared channel transmission for the at least one disabled HARQ process and receive a downlink control information transmission and its corresponding physical downlink shared channel transmission for the at least one enabled HARQ process. The downlink control information transmissions for the at least one disabled HARQ process and the at least one enabled HARQ process indicate a same subframe where a HARQ-acknowledgement transmission is to be transmitted. The wireless device and/or radio interface and/or processing circuitry is further configured to transmit the HARQ-acknowledgement transmission in the indicated subframe. The HARQ-acknowledgement transmission is based on a respective HARQ-acknowledgement bit for the at least one disabled HARQ process and the at least one enabled HARQ process. An acknowledgment bit is generated as HARQ-acknowledgement bit for the enabled at least one HARQ process if the physical downlink shared channel transmission for the at least one enabled HARQ process was successfully decoded, and a non-acknowledgment bit otherwise. An acknowledgment bit is generated as HARQ-acknowledgement bit for the disabled at least one HARQ process regardless of whether the physical downlink shared channel transmission for the at least one disabled HARQ process was successfully decoded or not.

A fourth aspect of the invention provides a network node configured to communicate with a wireless device via a non-terrestrial network, NTN. The network node configured to, and/or comprising a radio interface and/or comprising processing circuitry configured to determine to disable at least one hybrid automatic repeat request, HARQ, process and to enable at least one other HARQ process and signal an indication that is configured to disable the at least one HARQ process and to enable the at least one other HARQ process at the wireless device. The network node and/or radio interface and/or processing circuitry is further configured to transmit a downlink control information transmission and its corresponding physical downlink shared channel transmission for the at least one disabled HARQ process and transmit a downlink control information transmission and its corresponding physical downlink shared channel transmission for the at least one enabled HARQ process. The downlink control information transmissions for the at least one disabled HARQ process and the at least one enabled HARQ process indicate a same subframe where a HARQ-acknowledgement transmission is to be transmitted. The network node and/or radio interface and/or processing circuitry is further configured to receive the HARQ-acknowledgement transmission in the indicated subframe. The HARQ-acknowledgement transmission is based on a respective HARQ-acknowledgement bit for the at least one disabled HARQ process and the at least one enabled HARQ process.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example table of combined usage of 14 HARQ processes and HARQ-ACK bundling for Cat-M1 HD-FDD wireless device.

FIG. 2 is an example time progression of the table in FIG. 1.

FIG. 3 is an example table of combined usage of 10 HARQ processes and HARQ-ACK bundling for a Cat-M1 HD-FDD UE for NTN (LEO satellite with an orbit altitude of 600 Km).

FIG. 4 is an example of time progression of the table in FIG. 3;

FIG. 5 is a schematic diagram of an example network architecture illustrating a communication system connected via an intermediate network to a host computer according to the principles in the present disclosure.

FIG. 6 is a block diagram of a host computer communicating via a network node with a wireless device over an at least partially wireless connection according to some embodiments of the present disclosure.

FIG. 7 is a flowchart illustrating example methods implemented in a communication system including a host computer, a network node and a wireless device for executing a client application at a wireless device according to some embodiments of the present disclosure.

FIG. 8 is a flowchart illustrating example methods implemented in a communication system including a host computer, a network node and a wireless device for receiving user data at a wireless device according to some embodiments of the present disclosure.

FIG. 9 is a flowchart illustrating example methods implemented in a communication system including a host computer, a network node and a wireless device for receiving user data from the wireless device at a host computer according to some embodiments of the present disclosure.

FIG. 10 is a flowchart illustrating example methods implemented in a communication system including a host computer, a network node and a wireless device for receiving user data at a host computer according to some embodiments of the present disclosure.

FIG. 11 is a flowchart of an example process in a network node according to some embodiments of the present disclosure.

FIG. 12 is a flowchart of an example process in a wireless device according to some embodiments of the present disclosure.

FIG. 13 is an example table of first scheduling cycle with enabled HARQ feedback.

FIG. 14 is an example table of second (disabled HARQ feedback) and third (Enabled/Disabled HARQ feedback) scheduling cycles.

FIG. 15 is an example table of continuation of the third scheduling cycle (Enabled/Disabled HARQ feedback) and beginning of a fourth scheduling cycle.

### DETAILED DESCRIPTION

As discussed above, the support of IoT over NTN may in principle inherit or re-use as much as possible the existing frameworks of LTE-MTC and NB-IoT. Disabling HARQ feedback may require performing some changes depending on the disabling design per-se, and the due to the ability of enabling/disabling the HARQ feedback (e.g., nowadays HARQ feedback is meant to be enabled, but in Rel-18 for IoT NTN it is expected that the HARQ feedback can be either enabled or disabled).

In other words, the Rel-18 objective on “Disabling HARQ feedback” for IoT-NTN has considered the possibility of enabling and disabling HARQ feedback, but one or more embodiments described herein provide methods for the “HARQ-ACK bundling” to handle a scenario where all HARQ processes have been disabled, and a hybrid scenario where one or more of the HARQ processes have the HARQ feedback disabled, whereas the rest of the HARQ processes keep their HARQ feedback enabled.

Before describing in detail example embodiments, it is noted that the embodiments reside primarily in combinations of apparatus components and processing steps related to disabling at least one HARQ process in, for example, IoT-NTN. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

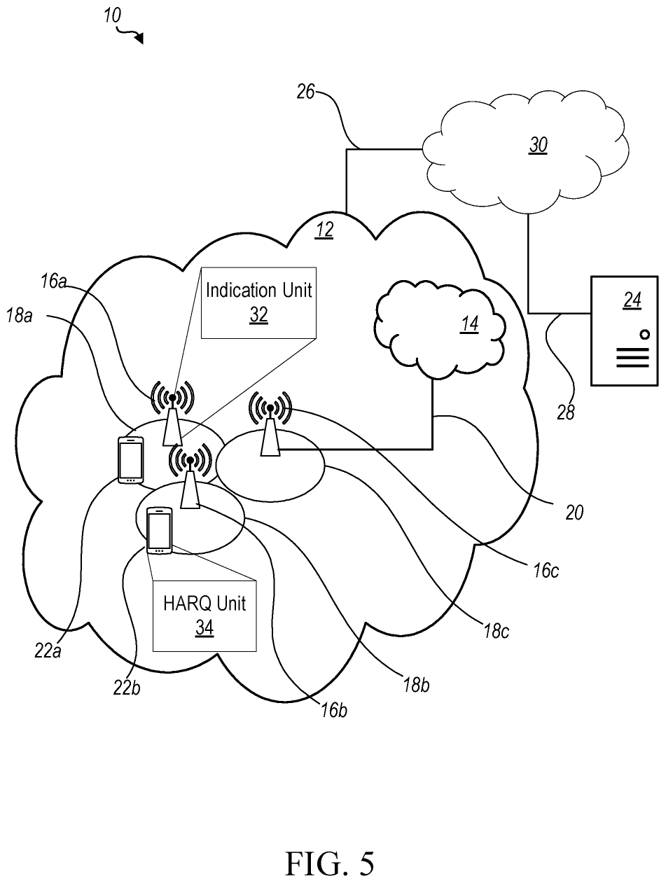

Referring now to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 5 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an indication unit 32 which is configured to perform one or more network node functions described herein such as with respect to disabling at least one HARQ process in, for example, IoT-NTN. A wireless device 22 is configured to include a HARQ unit 34 which is configured to perform one or more wireless device 22 functions as described herein such as with respect to disabling at least one HARQ process in, for example, IoT-NTN.

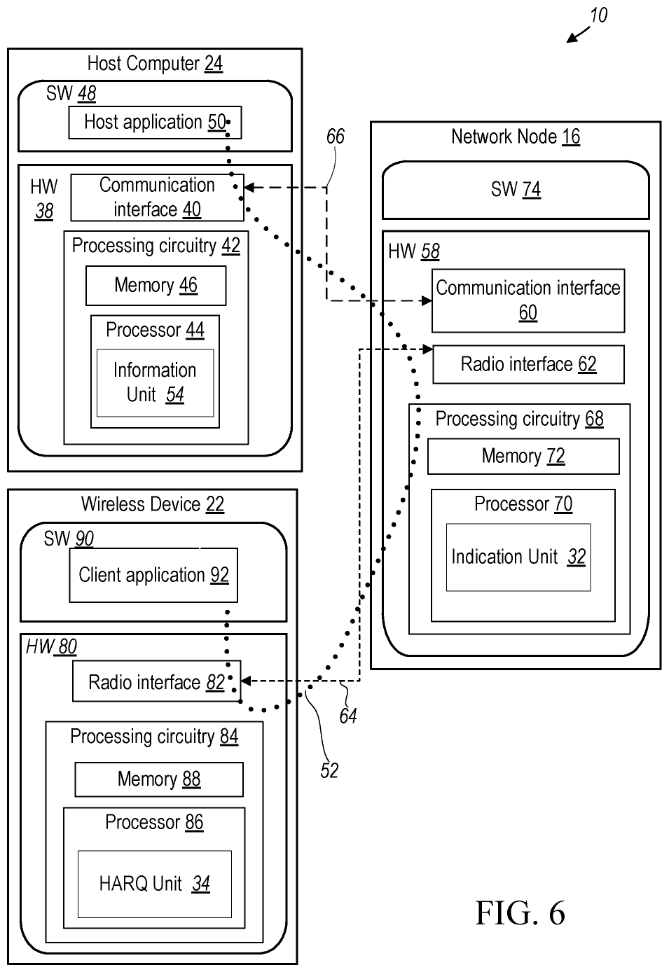

Example implementations, in accordance with an embodiment, of the WD 22, network node 16 and host computer 24 discussed in the preceding paragraphs will now be described with reference to FIG. 6. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more relay, forward, transmit, receive, process, determine, store, etc. information related to disabling at least one HARQ process in, for example, IoT-NTN.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include indication unit 32 configured to perform one or more network node 16 functions as described herein such as with respect to disabling at least one HARQ process in, for example, IoT-NTN.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a HARQ unit 34 configured to perform one or more wireless device 22 functions as described herein such as with respect to disabling at least one HARQ process in, for example, IoT-NTN.

In some embodiments, the inner workings of the network node 16, WD 22, and host computer 24 may be as shown in FIG. 6 and independently, the surrounding network topology may be that of FIG. 5.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 5 and 6 show various “units” such as indication unit 32, and HARQ unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

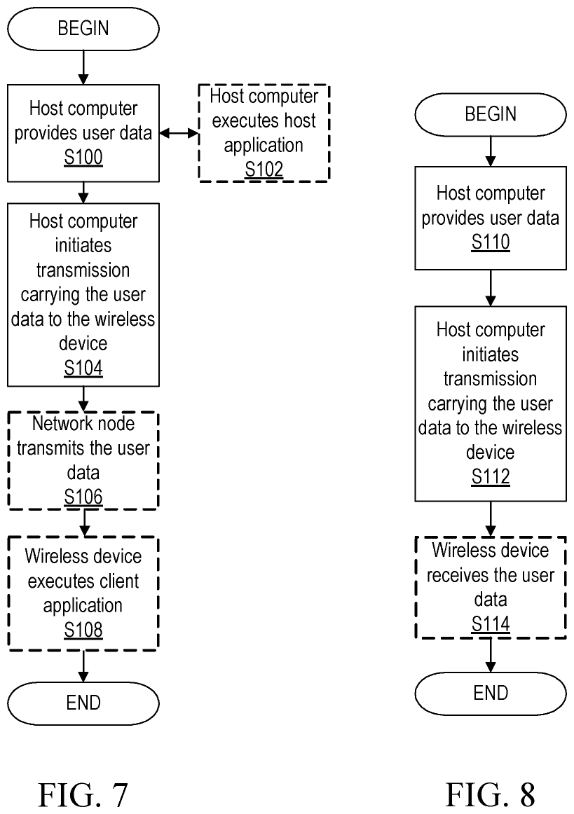

FIG. 7 is a flowchart illustrating an example method implemented in a communication system, such as, for example, the communication system of FIGS. 5 and 6, in accordance with one embodiment. The communication system may include a host computer 24, a network node 16 and a WD 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 8 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

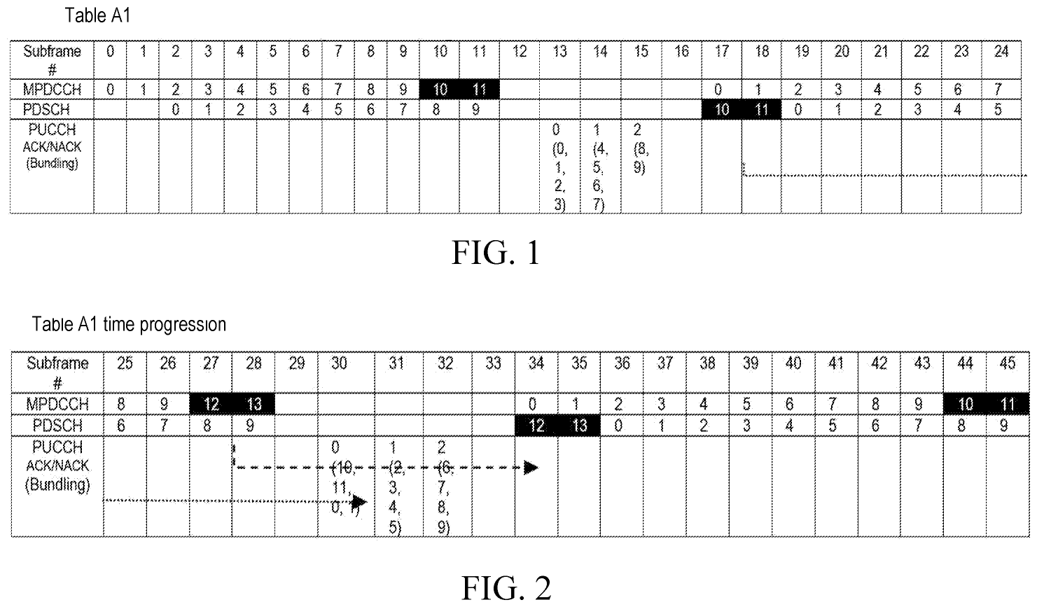

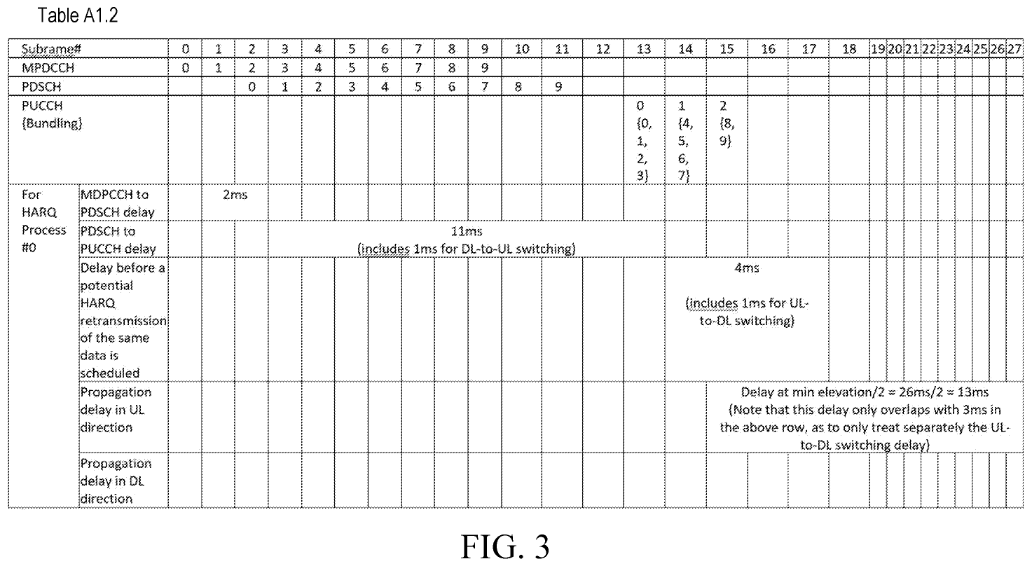

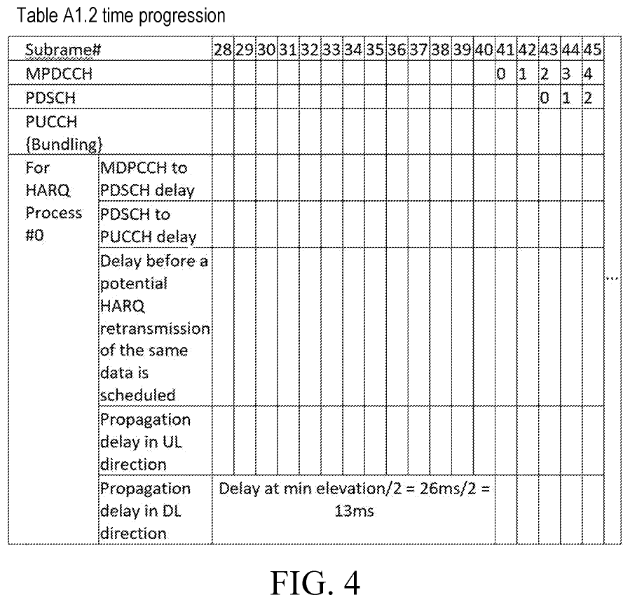

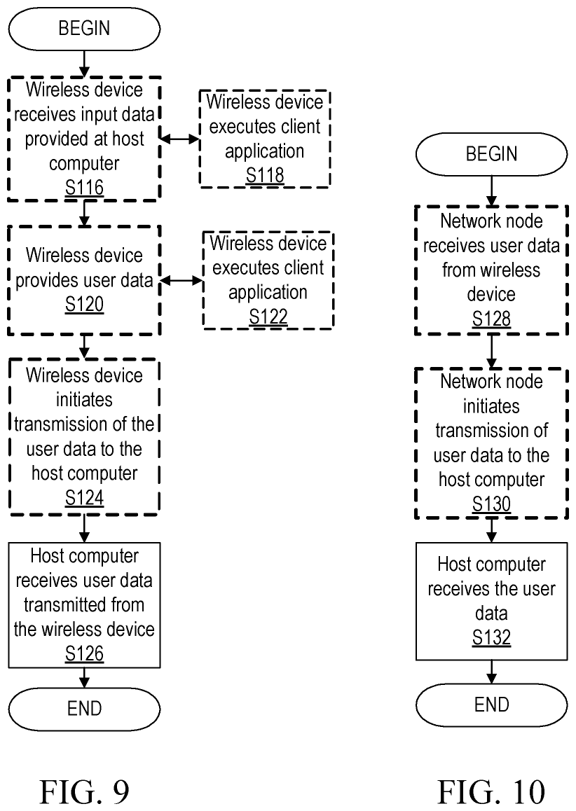

FIG. 9 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 10 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

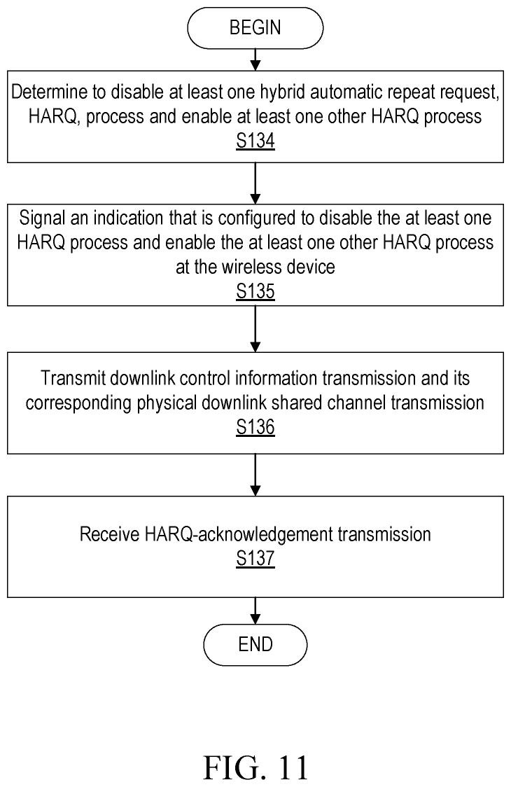

FIG. 11 is a flowchart of an example process in a network node 16 according to one or more embodiments of the present disclosure. One or more blocks described herein may be performed by one or more elements of network node 16 such as by one or more of processing circuitry 68 (including the indication unit 32), processor 70, radio interface 62 and/or communication interface 60. Network node 16 is configured to determine (Block S134) to disable at least one hybrid automatic repeat request, HARQ, process, and enable at least one other HARQ process, as described herein. Network node 16 is configured to signal (Block S135) an indication that is configured to disable the at least one HARQ process and enable the at least one other HARQ process at the wireless device 22, as described herein. Network node 16 is configured to transmit (Block S136) a downlink control information transmission and its corresponding physical downlink shared channel transmission, at least one for the enabled at least one HARQ process and at least one for the disabled at least one HARQ process, as described herein. Network node 16 is configured to receive (Block S137) a HARQ-acknowledgement transmission, as described herein.

The downlink control information transmissions for the at least one disabled HARQ process and the at least one enabled HARQ process may indicate a same subframe where a HARQ-acknowledgement transmission is to be transmitted. The HARQ-acknowledgement transmission is then received in the indicated subframe. The HARQ-acknowledgement transmission may be based on a respective HARQ-acknowledgement bit for the at least one disabled HARQ process and the at least one enabled HARQ process.

Some embodiments provide for disabling at least one HARQ process in, for example, internet of things-non-terrestrial network (IoT-NTN).

According to one or more embodiments, the signaling of the indication is performed using one of downlink control information, DCI, signaling and radio resource control, RRC, signaling. According to one or more embodiments, the indication is configured to cause the wireless device 22 to one of: ignore a value of a HARQ delay field as not present; ignore a value of a transport blocks in a bundle field; and ignore a value of a HARQ bundling flag.

According to one or more embodiments, the indication is configured to cause the wireless device to implicitly interpret a Physical Downlink Shared Channel (PDSCH) schedule delay field. According to one or more embodiments, disabling at least one HARQ process corresponds to the wireless device ignoring at least one HARQ process. According to one or more embodiments, the at least one HARQ process corresponds to one of: all HARQ processes at the wireless device; and less than all HARQ processes at the wireless device.

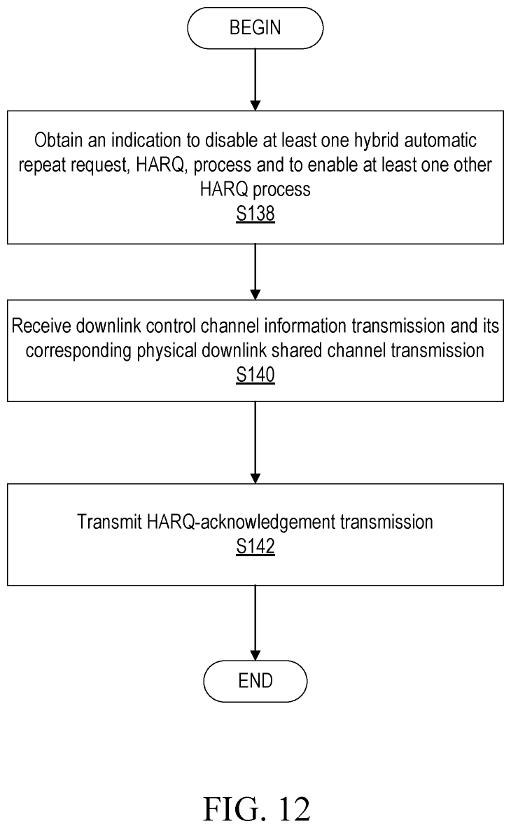

FIG. 12 is a flowchart of an example process in a wireless device 22 according to some embodiments of the present disclosure. One or more blocks described herein may be performed by one or more elements of wireless device 22 such as by one or more of processing circuitry 84 (including the HARQ unit 34), processor 86, radio interface 82 and/or communication interface 60. Wireless device 22 is configured to obtain (Block S138) an indication to disable at least one hybrid automatic repeat request, HARQ, process, and to enable at least one HARQ process, as described herein. Wireless device 22 is configured to receive (Block S140) a downlink control channel transmission and its corresponding physical downlink shared channel transmission, at least one for the enabled at least one HARQ process and at least one for the disabled at least one HARQ process, as described herein. Wireless device 22 is configured to transmit (Block S142) a HARQ-acknowledgement transmission, as described herein.

The downlink control information transmissions for the at least one disabled HARQ process and the at least one enabled HARQ process may indicate a same subframe where the HARQ-acknowledgement transmission is to be transmitted. The HARQ-acknowledgement transmission is then transmitted in the indicated subframe. The HARQ-acknowledgement transmission may be based on a respective HARQ-acknowledgement bit for the at least one disabled HARQ process and the at least one enabled HARQ process. An acknowledgment bit may be generated as HARQ-acknowledgement bit for the enabled at least one HARQ process if the physical downlink shared channel transmission for the at least one enabled HARQ process was successfully decoded, and a non-acknowledgment bit otherwise. An acknowledgment bit may be generated as HARQ-acknowledgement bit for the disabled at least one HARQ process regardless of whether the physical downlink shared channel transmission for the at least one disabled HARQ process was successfully decoded or not.

According to one or more embodiments, the disabling of the at least one HARQ process corresponds to one of: ignoring a value of a HARQ delay field; ignoring a value of a transport blocks in a bundle field; and ignoring a value of a HARQ bundling flag. According to one or more embodiments, the processing circuitry 84 is further configured to implicitly interpret a physical downlink shared channel, PDSCH, schedule delay field based on the indication.

According to one or more embodiments, the signaling of the indication is one of downlink control information, DCI, signaling and radio resource control, RRC, signaling. According to one or more embodiments, disabling at least one HARQ process corresponds to the wireless device 22 ignoring at least one HARQ process. According to one or more embodiments, the at least one HARQ process corresponds to one of: all HARQ processes at the wireless device 22; and less than all HARQ processes at the wireless device 22.

Having described the general process flow of arrangements of the disclosure and having provided examples of hardware and software arrangements for implementing the processes and functions of the disclosure, the sections below provide details and examples of arrangements for disabling at least one HARQ process in, for example, IoT-NTN. In one or more embodiments, disabling of a HARQ process may refer to a wireless device 22 ignoring a HARQ process or a portion of signaling associated with the HARQ process. In one or more embodiments, ignoring a HARQ process at the wireless device may mean that the HARQ process continues to run at the network node 16 but that the network node 16 may recognize that the wireless device 22 is ignoring the HARQ process.

Some embodiments provide disabling at least one HARQ process in, for example, IoT-NTN.

One or more network node 16 functions described below may be performed by one or more of processing circuitry 68, processor 70, indication unit 32, etc. One or more wireless device 22 functions described below may be performed by one or more of processing circuitry 84, processor 86, HARQ unit 34, etc.

The gain from disabling HARQ feedback may come from avoiding the propagation delay in the uplink direction due to not having to transmit ACK/NACK via Physical Uplink Control Channel (PUCCH), plus the ability to receive the subsequent MTC Physical Downlink Control Channel (MPDCCH) scheduling data as soon as DL monitoring is allowed. The design for disabling HARQ feedback is in discussion and still remains to be accepted into 3GPP standards.

On the other hand, IoT NTN has a variety of scenarios, different satellites, orbit altitudes, coverage levels and therefore IoT NTN may be equipped with the ability of enabling/disabling HARQ feedback on a per need basis. In line with it, the initial discussion on the Rel-18 work item objective for disabling HARQ feedback have discussed the possibility of enabling and disabling HARQ feedback.

In relation with the above, when the HARQ feedback is enabled, “HARQ-ACK bundling” (which is an LTE-MTC functionality) helps to alleviate the HARQ stalling on the wireless device data rate. The “HARQ-ACK bundling”, as explained above, allows to ACK/NACK up to four HARQ processes using a single PUCCH transmission. On this matter, several problems to be solved, by one or more embodiments, for IoT NTN is a scenario where all HARQ processes have their HARQ feedback disabled and hybrid scenarios where one or more of the HARQ processes have the HARQ feedback enabled, whereas other HARQ processes have the HARQ feedback disabled.

Below described one or more embodiments for the “HARQ-ACK bundling” to handle a IoT NTN scenario where all HARQ processes have their HARQ feedback disabled, and a hybrid IoT NTN scenario where one or more of the HARQ processes have the HARQ feedback enabled, whereas other HARQ processes have the HARQ feedback disabled.

### “HARQ-ACK Bundling” Handling Enabling/Disabling of HARQ Feedback.

In existing systems, in the legacy specification, it is possible to indicate dynamically (i.e., via DCI) the “HARQ process number” as described in 3GPP TS 36.212, version 17.0.0, which in one embodiment allows for the possibility of indicating as well via DCI whether a given “HARQ process number” will have its HARQ feedback enabled or disabled.

In one embodiment, a new field in DCI (e.g., DCI Format 6-1A and/or DCI Format 6-1B) can be added to 3GPP specification (e.g., 3GPP TS 36.212) to indicate (e.g., using 1-bit) whether the HARQ feedback is enabled or disabled for the HARQ process number that is indicated via DCI using the “HARQ process number field”.

In one other embodiment, the HARQ process number is kept indicated via DCI as per legacy 3GPP specification, whereas the indication on which HARQ processes will have their HARQ feedback enabled or disabled is indicated semi-statically via RRC signaling.

In one embodiment, when semi-static signaling is used to indicate whether the HARQ feedback is enabled or disabled, the semi-static configuration can include indicating either that all HARQ processes will have their HARQ feedback enabled, that all HARQ processes will have their HARQ feedback disabled, or it can explicitly indicate which “HARQ process number” from among all configurable HARQ processes will have HARQ feedback enabled, and which will have HARQ feedback disabled.

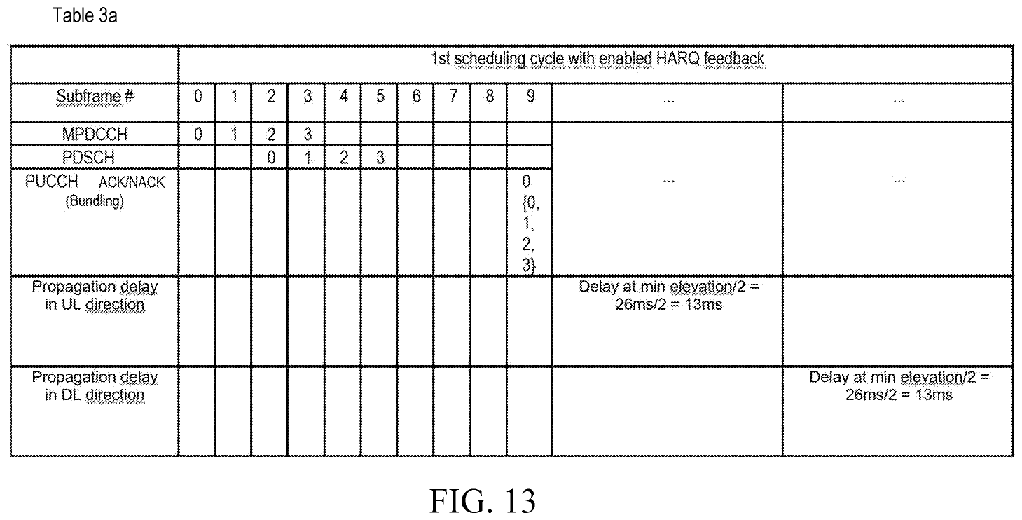

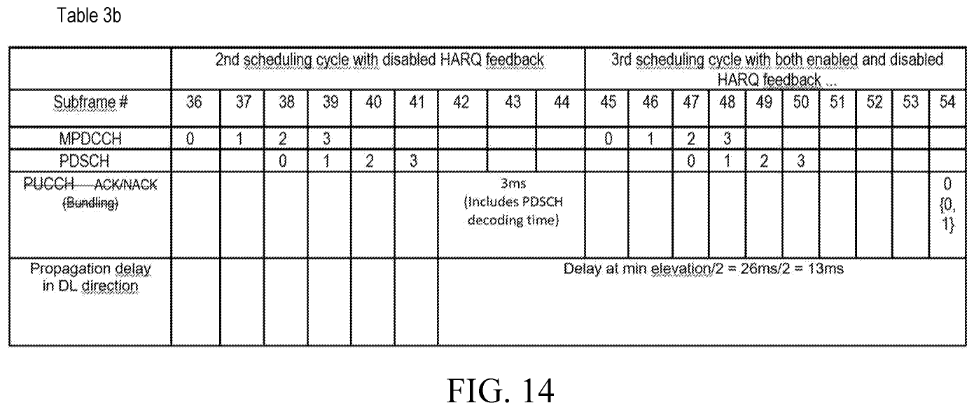

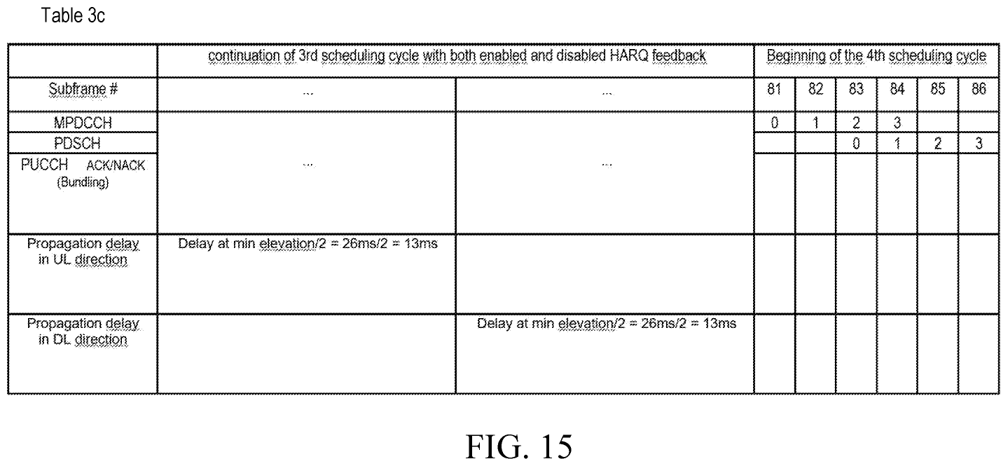

The following descriptions are agnostic to the signaling type (e.g., dynamic or semi-static signaling) indicating whether the HARQ feedback is enabled or disabled. Using an LTE-MTC framework, Tables 3a, 3b, 3c in FIGS. 13, 14 and 15, respectively, illustrate as an example a scenario assuming a LEO satellite at an orbit altitude of 600 km where four HARQ processes are in use across four consecutive scheduling cycles (Note: A new scheduling cycle refers to starting over the transmission of the HARQ processes), in the first scheduling cycle HARQ feedback is enabled for all HARQ processes (Table 3a), in the second scheduling cycle HARQ feedback is disabled for all HARQ processes (left hand-side of Table 3b), in the third scheduling cycle some HARQ processes have HARQ feedback enabled whereas some other HARQ processes have the HARQ feedback disabled (right hand-side of Table 3b), and finally in the fourth scheduling cycle it is depicted for reference and illustration purposes the scheduling of yet another set of HARQ processes (Table 3c), there illustrating, for example, the time progression.

The first scheduling cycle illustrates the case were all HARQ processes (i.e., HARQ process #0, #1, #2, and #3) have their HARQ-ACK feedback enabled, meaning that PUCCH is transmitted to indicate an ACK or NACK depending on the successful or not successful decoding of PDSCH for HARQ process #0, #1, #2, and #3. On this matter, HARQ-ACK bundling is utilized to provide an ACK or NACK using a single PUCCH transmission at subframe #9 (recall that with “HARQ-ACK bundling” an ACK is sent if all PDSCHs were successfully decoded at the wireless device 22, and a NACK otherwise).
a) First scheduling cycle with enabled HARQ feedback when “ce-pdsch-tenProcesses-config” is configured.
   In this case, since HARQ feedback is enabled, the legacy procedure is just followed. That is, the PDSCH is transmitted two subframes after the end of the corresponding MPDCCH for a given HARQ process, this delay is referred to as “PDSCH scheduling delay” and is implicitly known to always be 2 BL/CE DL subframes (i.e., it is not signaled) when “ce-pdsch-tenProcesses-config” is configured. On the other hand, the delay from the subframe after the PDSCH transmission to the subframe where PUCCH is transmitted is known as “HARQ-ACK delay” and is signaled via DCI using the “HARQ-ACK delay” field (it can take several values, being the shortest one 4 subframes as applied in Table 3a). Afterwards, in IoT NTN, there is a gap created by the uplink propagation delay and downlink propagation delay before we can see the beginning of the next scheduling cycle at subframe #36 as depicted in Table 3b.
b) First scheduling cycle with enabled HARQ feedback when “ce-PDSCH-14HARQ-Config-r17” is configured.
   In this case the legacy procedure is also followed, just that when “ce-PDSCH-14HARQ-Config-r17” is configured both the “PDSCH scheduling delay” and “HARQ-ACK delay” are signaled in a joint encoding manner via DCI (recall this feature allows to schedule up to 14 HARQ processes, and because of that longer PDSCH scheduling delays are required which need to be signaled). In this example, the PDSCH is transmitted two subframes after the end of the corresponding MPDCCH for a given HARQ process, this delay is known as “PDSCH scheduling delay” and is signaled via DCI using the “PDSCH scheduling delay and HARQ-ACK delay for 14 HARQ” field. On the other hand, the delay from the subframe after the PDSCH transmission to the subframe where PUCCH is transmitted is known as “HARQ-ACK delay” which minimum value encompasses 4 subframes (as applied in Table 3a) and is signaled via DCI also using the “PDSCH scheduling delay and HARQ-ACK delay for 14 HARQ” field. Afterwards, there is a gap created by the uplink propagation delay and downlink propagation delay before the beginning of the next scheduling cycle at subframe #36 as depicted in Table 3b.

The second scheduling cycle spans from subframe #36 till subframe #44 and in this case all HARQ processes (i.e., HARQ process #0, #1, #2, and #3) have their HARQ-ACK feedback disabled, meaning that PUCCH is not transmitted (hence there is no propagation delay in the uplink direction). In addition, the intention behind disabling HARQ-ACK feedback may be to transmit in DL as early as possible (somehow in advance) while the propagation delay in the DL direction is still ongoing. In the framework above and in one embodiment when HARQ-ACK feedback is disabled, the earliest the DL monitoring should start is precisely the subframe at which PUCCH would be otherwise transmitted (i.e., subframe #45 in Table 3b), this allows preserving (for sufficient PDSCH decoding purposes) at least a 3 ms delay between the end of the PDSCH and the start of the DL monitoring.
a) Second scheduling cycle with disabled HARQ feedback when “ce-pdsch-tenProcesses-config” is configured.
   It is still to be decided, in 3GPP, the signaling method to indicate that the HARQ feedback has been enabled or disabled. Regardless of the signaling type (e.g., dynamic signaling via DCI, semi-static signaling via RRC, etc.), in one embodiment the indication that the HARQ feedback is disabled can be used by the wireless device 22 to:
      1) Treat the “HARQ-ACK delay” field as not present when HARQ feedback has been indicated to be disabled. Another embodiment ignores or omits the delay value provided by the “HARQ-ACK delay” field when HARQ feedback has been indicated to be disabled.
      2) Treat the “Transport blocks in a bundle” field as not present when HARQ feedback has been indicated to be disabled. Another embodiment ignores or omits the indication provided by the “Transport blocks in a bundle” field when HARQ feedback has been indicated to be disabled.
      3) Interpret the “HARQ-ACK bundling flag” field as having the value 0 when HARQ feedback has been indicated to be disabled, which in turn will indicate the HARQ-ACK bundling is not enabled.
         On the other hand, when “ce-pdsch-tenProcesses-config” is configured the “PDSCH scheduling delay” is implicitly assumed to be 2 BL/CE DL subframes (i.e., it is not signaled), which remains used as legacy when HARQ feedback has been disabled.
b) Second scheduling cycle with disabled HARQ feedback when “ce-PDSCH-14HARQ-Config-r17” is configured.
   In one embodiment, the indication that the HARQ feedback is disabled (regardless of the signaling type used to indicate the disabling e.g., dynamic signaling via DCI, semi-static signaling via RRC, etc.) can be used by the wireless device 22 to:
      1) Only make use of the “PDSCH scheduling delay option”, ignoring or omitting the “HARQ-ACK delay” value from either Table 5.3.3.1.12-1 or Table 5.3.3.1.12-2 of 3GPP. That is, via DCI the “PDSCH scheduling delay and HARQ-ACK delay for 14 HARQ” field provides a “Bit field mapped to index”, which is used in Table 5.3.3.1.12-1 and Table 5.3.3.1.12-2 to obtain the “PDSCH scheduling delay option” and the “HARQ-ACK delay”, whereas the former one can be used as in legacy, the latter one can be ignored or omitted by the wireless device 22 when HARQ feedback has been indicated to be disabled.
      2) If for IoT-NTN only up to 10 HARQ processes are allowed to be used and HARQ feedback has been indicated to be disabled, then the “PDSCH scheduling delay and HARQ-ACK delay for 14 HARQ” field can be treated as not present, and the “PDSCH scheduling delay” can be interpreted to be implicitly given (i.e., 2 BL/CE DL subframes) as when “ce-pdsch-tenProcesses-config” is configured.
      3) Treat the “Transport blocks in a bundle” field as not present when HARQ feedback has been indicated to be disabled. Another possibility is to ignore or omit the indication provided by the “Transport blocks in a bundle” field when HARQ feedback has been indicated to be disabled.
      4) Interpret the “HARQ-ACK bundling flag” field as having the value 0 when HARQ feedback has been indicated to be disabled, which in turn will indicate the HARQ-ACK bundling is not enabled.

The third scheduling cycle spans from subframe #45 till subframe #80. In this case, it has been indicated that HARQ processes #0 and #1 have their HARQ feedback enabled, whereas HARQ processes #2 and #3 have their HARQ feedback disabled. Previously, it has been mentioned that the one gain from disabling HARQ feedback comes from not having to transmit PUCCH plus the ability to schedule subsequent HARQ processes earlier, however, as long as one HARQ process among the ones in use is indicated to have HARQ feedback enabled, then in principle PUCCH may need to be transmitted may somehow overrides the gain for the HARQ processes which have been indicated to have their HARQ feedback disabled.
a) Third scheduling cycle with both enabled and disabled HARQ feedback
   Alternative 1:
      For the HARQ process that are indicated to have HARQ feedback enabled (in one example, HARQ process #0 and #1). The legacy procedure is followed as described for the first scheduling cycle (when HARQ feedback is enabled) in Table 3a.
      For the HARQ process that are indicated to have HARQ feedback disabled (in one example, HARQ process #2 and #3). The method described for the second scheduling cycle (when HARQ feedback is disabled) in Table 3b is applied.
   Alternative 2:
      For the HARQ process that are indicated to have HARQ feedback enabled (in one example, HARQ process #0 and #1). The legacy procedure is followed as described for the first scheduling cycle (when HARQ feedback is enabled) in Table 3a.
      For the HARQ process that are indicated to have HARQ feedback disabled (in one example, HARQ process #2 and #3). Due to that in the same scheduling cycle at least one HARQ process has been required to have HARQ feedback enabled and hence PUCCH has to be transmitted, then by default ACKs are generated or assumed for HARQ processes #2 and #3, and the legacy procedure is followed for all HARQ processes as described for the first scheduling cycle (when HARQ feedback is enabled) in Table 3a.
   Alternative 3:
      As mentioned above, as long as one HARQ process among the ones in use is indicated to have HARQ feedback enabled, then PUCCH may need to be transmitted which may somehow override the gain for the HARQ processes which have been indicated to have their HARQ feedback disabled. To avoid losing the gain from disabling HARQ feedback, in a hybrid scenario where among all HARQ processes in use there is at least one HARQ process with HARQ feedback disabled, PUCCH is not transmitted at that scheduling cycle and, at the network node 16, by default an ACK (or alternatively a NACK) is assumed for all HARQ processes with HARQ feedback enabled. That is:
      For the HARQ process that are indicated to have HARQ feedback enabled (in one example, HARQ process #0 and #1). Due to that in the same scheduling cycle at least one HARQ process has been required to have HARQ feedback disabled, then PUCCH is not transmitted and the network node 16 by default assumes ACKs (or alternative NACKs) for HARQ processes #0 and #1, and at the wireless device 22 side, the method/embodiment(s) described for the second scheduling cycle (when HARQ feedback is disabled) in Table 3b is applied.
      For the HARQ process that are indicated to have HARQ feedback disabled (in one example, HARQ process #2 and #3). The method described for the second scheduling cycle (when HARQ feedback is disabled) in Table 3b is applied.

Further, Table 3c, illustrates the beginning of the fourth scheduling cycle without specifying whether HARQ feedback has been enabled or disabled for those HARQ processes. The intention of having depicted the 4th scheduling cycle was for illustration purposes to show the end of the third scheduling cycle and the beginning of the subsequent scheduling cycle, and should not be interpreted to limit one or more embodiments described herein.

In one embodiment, the methods are applicable to both a transparent payload satellite architecture (known as “bent-pipe”) and a non-transparent satellite architecture (known as “Regenerative satellite”), where the latter has a shorter roundtrip time since the satellite is equipped with network node 16 functionalities that allow reaching wireless devices 22 located on earth in a faster manner.

The teachings of the methods/embodiments described herein can be applicable to other features (e.g., Multi-TB grant), and even other radio access technologies (e.g., NB-IoT) that make use of HARQ-ACK bundling in NTN communications.

One or more embodiments for the “HARQ-ACK bundling” to handle disabling/enabling of HARQ feedback in Non-Terrestrial Networks provide one or more of the following advantages:
One or more embodiments account for recent 3GPP agreements where both enabling and disabling of HARQ feedback have been considered for IoT-NTN.
The “HARQ-ACK bundling” functionality described herein is able to handle a hybrid scenario where some of the HARQ processes have the HARQ feedback enabled, whereas some other HARQ processes have the HARQ feedback disabled.
One or more embodiments described herein are agnostic to the satellite's type and orbit altitudes.
The specification impact (e.g., changes to 3GPP specifications to implement the teachings described herein) is kept to the minimum.
One or more embodiments described herein are expected to work with all the features that make use of the “HARQ-ACK bundling” functionality (e.g., ce-pdsch-tenProcesses-config, ce-PDSCH-14HARQ-Config-r17).

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
ACK Acknowledgement
BL/CE Bandwidth-reduced Low-complexity or Coverage Enhanced
DCI Downlink Control Information
DL Downlink
GEO Geosynchronous Orbit
HARQ Hybrid Automatic Repeat Request
HD-FDD Half Duplex-Frequency Division Duplex
LEO Low Earth Orbit
LTE Long-Term Evolution
MPDCCH MTC Physical Downlink Control Channel
MTC Machine Type Communication
NTN Non-Terrestrial Networks
NACK Non-Acknowledgement
PDSCH Physical Downlink Shared Channel
PUCCH Physical Uplink Control Channel
TBS Transport Block Size
TN Terrestrial Networks
UL Uplink
WI Work Item
WID Work Item Description

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### EXAMPLE EMBODIMENTS

Embodiment A1. A network node configured to communicate with a wireless device via a non-terrestrial network, NTN, the network node configured to, and/or comprising a radio interface and/or comprising processing circuitry configured to:
determine to disable at least one hybrid automatic repeat request, HARQ, process; and
signal an indication that is configured to disable the at least one HARQ process at the wireless device.
Embodiment A2. The network node of Embodiment A1, wherein the signaling of the indication is performed using one of downlink control information, DCI, signaling and radio resource control, RRC, signaling.
Embodiment A3. The network node of Embodiment A1, wherein the indication is configured to cause the wireless device to one of:
ignore a value of a HARQ delay field as not present;
ignore a value of a transport blocks in a bundle field; and
ignore a value of a HARQ bundling flag.
Embodiment A3. The network node of Embodiment A1, wherein the indication is configured to cause the wireless device to implicitly interpret a PDSCH schedule delay field.
Embodiment A4. The network node of Embodiment A1, wherein disabling at least one HARQ process corresponds to the wireless device ignoring at least one HARQ process.
Embodiment A5. The network node of Embodiment A1, wherein the at least one HARQ process corresponds to one of:
all HARQ processes at the wireless device; and
less than all HARQ processes at the wireless device.
Embodiment B1. A method implemented in a network node that is configured to communicate with a wireless device via a non-terrestrial network, NTN, the method comprising:
determining to disable at least one hybrid automatic repeat request, HARQ, process; and
signaling an indication that is configured to disable the at least one HARQ process at the wireless device.
Embodiment B2. The method of Embodiment B1, wherein the signaling of the indication is performed using one of downlink control information, DCI, signaling and radio resource control, RRC, signaling.
Embodiment B3. The method of Embodiment B1, wherein the indication is configured to cause the wireless device to one of:
ignore a value of a HARQ delay field as not present;
ignore a value of a transport blocks in a bundle field; and
ignore a value of a HARQ bundling flag.
Embodiment B3. The method of Embodiment B1, wherein the indication is configured to cause the wireless device to implicitly interpret a PDSCH schedule delay field.
Embodiment B4. The method of Embodiment B1, wherein disabling at least one HARQ process corresponds to the wireless device ignoring at least one HARQ process.
Embodiment B5. The method of Embodiment B1, wherein the at least one HARQ process corresponds to one of:
all HARQ processes at the wireless device; and
less than all HARQ processes at the wireless device.
Embodiment C1. A wireless device configured to communicate with a network node via a non-terrestrial network, NTN, the wireless device configured to, and/or comprising a radio interface and/or processing circuitry configured to:
receive signaling of an indication to disable at least one hybrid automatic repeat request, HARQ, process; and
disable the at least one HARQ process based on the indication.
Embodiment C2. The wireless device of Embodiment C1, wherein the disabling of the at least one HARQ process corresponds to one of:
ignoring a value of a HARQ delay field;
ignoring a value of a transport blocks in a bundle field; and
ignoring a value of a HARQ bundling flag.
Embodiment C3. The wireless device of Embodiment C1, wherein the processing circuitry is further configured to implicitly interpret a physical downlink shared channel, PDSCH, schedule delay field based on the indication.
Embodiment C4. The wireless device of Embodiment C1, wherein the signaling of the indication is one of downlink control information, DCI, signaling and radio resource control, RRC, signaling.
Embodiment C5. The wireless device of Embodiment C1, wherein disabling at least one HARQ process corresponds to the wireless device ignoring at least one HARQ process.
Embodiment C6. The wireless device of Embodiment C1, wherein the at least one HARQ process corresponds to one of:
all HARQ processes at the wireless device; and
less than all HARQ processes at the wireless device.
Embodiment D1. A method implemented by a wireless device that is configured to communicate with a network node via a non-terrestrial network, NTN, the method comprising:
receiving signaling of an indication to disable at least one hybrid automatic repeat request, HARQ, process; and
disabling the at least one HARQ process based on the indication.
Embodiment D2. The method of Embodiment D1, wherein the disabling of the at least one HARQ process corresponds to one of:
ignoring a value of a HARQ delay field;
ignoring a value of a transport blocks in a bundle field; and
ignoring a value of a HARQ bundling flag.
Embodiment D3. The method of Embodiment D1, further comprising implicitly interpreting a physical downlink shared channel, PDSCH, schedule delay field based on the indication.
Embodiment D4. The method of Embodiment D1, wherein the signaling of the indication is one of downlink control information, DCI, signaling and radio resource control, RRC, signaling.
Embodiment D4. The method of Embodiment D1, wherein disabling at least one HARQ process corresponds to the wireless device ignoring at least one HARQ process.
Embodiment D5. The method of Embodiment D1, wherein the at least one HARQ process corresponds to one of:
all HARQ processes at the wireless device; and
less than all HARQ processes at the wireless device.

1. A method implemented by a wireless device that is configured to communicate with a network node via a non-terrestrial network, NTN, the method comprising:
obtaining an indication to disable at least one hybrid automatic repeat request, HARQ, process and to enable at least one other HARQ process;
receiving a downlink control information transmission and its corresponding physical downlink shared channel transmission for the at least one disabled HARQ process;
receiving a downlink control information transmission and its corresponding physical downlink shared channel transmission for the at least one enabled HARQ process, the downlink control information transmissions for the at least one disabled HARQ process and the at least one enabled HARQ process indicating a same subframe where a HARQ-acknowledgement transmission is to be transmitted; and
transmitting the HARQ-acknowledgement transmission in the indicated subframe, the HARQ-acknowledgement transmission being based on a respective HARQ-acknowledgement bit for the at least one disabled HARQ process and the at least one enabled HARQ process, an acknowledgment bit being generated as HARQ-acknowledgement bit for the enabled at least one HARQ process if the physical downlink shared channel transmission for the at least one enabled HARQ process was successfully decoded, and a non-acknowledgment bit otherwise, and an acknowledgment bit being generated as HARQ-acknowledgement bit for the disabled at least one HARQ process regardless of whether the physical downlink shared channel transmission for the at least one disabled HARQ process was successfully decoded or not.

2. The method of claim 1, wherein the indication to disable at least one HARQ process and to enable at least one other HARQ process is obtained by receiving a Radio Resource Control, RRC, signaling.

3. The method of claim 1, wherein the indication to disable at least one HARQ process and to enable at least one other HARQ process is obtained by receiving the respective downlink control information transmission for the at least one disabled HARQ process and the at least one enabled HARQ process.

4. The method of claim 1, wherein the respective downlink control information transmission for the at least one disabled HARQ process and the at least one enabled HARQ process indicates a same subframe where a HARQ-acknowledgement transmission is to be transmitted via a respective HARQ-ACK delay indication, wherein the HARQ-ACK delay indication indicates the delay from the subframe after the corresponding physical downlink shared channel transmission to the subframe where HARQ-acknowledgement transmission is to be transmitted.

5. The method of claim 1, wherein the respective downlink control information transmission for the at least one enabled HARQ process and the at least one disabled HARQ process comprises a respective bundling flag set to 1.

6. The method of 1, wherein the downlink control information transmission for the at least one enabled HARQ process comprises a bundling flag set to 1 and the downlink control information transmission for the at least one disabled HARQ process comprises a bundling flag set to 0.

7. The method of claim 6, wherein the HARQ-acknowledgement transmission comprises one bundled HARQ-ACK bit, wherein the one bundled HARQ-ACK bit is generated by performing a logical AND operation of the respective HARQ-acknowledgment bits for the at least one enabled HARQ process and the at least one disabled HARQ process.

8. The method of claim 1, wherein the downlink control information transmissions are transmitted on a Machine Type Communication Physical Downlink Control Channel, MPDCCH, or a Narrowband-Internet of Things Physical Downlink Control Channel, NPDCCH.

9. A method implemented in a network node that is configured to communicate with a wireless device via a non-terrestrial network, NTN, the method comprising:
determining to disable at least one hybrid automatic repeat request, HARQ, process and to enable at least one other HARQ process;
signaling an indication that is configured to disable the at least one HARQ process and to enable the at least one other HARQ process at the wireless device;
transmitting a downlink control information transmission and its corresponding physical downlink shared channel transmission for the at least one disabled HARQ process;
transmitting a downlink control information transmission and its corresponding physical downlink shared channel transmission for the at least one enabled HARQ process, the downlink control information transmissions for the at least one disabled HARQ process and the at least one enabled HARQ process indicating a same subframe where a HARQ-acknowledgement transmission is to be transmitted; and
receiving the HARQ-acknowledgement transmission in the indicated subframe, the HARQ-acknowledgement transmission being based on a respective HARQ-acknowledgement bit for the at least one disabled HARQ process and the at least one enabled HARQ process.

10. The method of claim 9, wherein the signaling of the indication is performed using radio resource control, RRC, signaling.

11. The method of claim 9, wherein the signaling of the indication is performed by transmitting the respective downlink control information transmission for the at least one disabled HARQ process and the at least one enabled HARQ process.

12. The method of claim 9, wherein the respective downlink control information transmission indicates a same subframe where a HARQ-acknowledgement transmission is to be transmitted via a respective HARQ-ACK delay indication, wherein the HARQ-ACK delay indication indicates the delay from the subframe after the corresponding physical downlink shared channel transmission to the subframe where HARQ-acknowledgement transmission is to be transmitted.

13. The method of claim 9, wherein the respective downlink control information transmissions for the at least one enabled HARQ process and the at least one disabled HARQ process comprises a respective bundling flag set to 1.

14. The method of claim 9, wherein the downlink control information transmission for the at least one enabled HARQ process comprises a bundling flag set to 1 and the downlink control information transmission for the at least one disabled HARQ process comprises a bundling flag set to 0.

15. The method of claim 9, wherein the downlink control information transmissions are transmitted on a Machine Type Communication Physical Downlink Control Channel, MPDCCH, or a Narrowband-Internet of Things Physical Downlink Control Channel, NPDCCH.

16. A wireless device configured to communicate with a network node via a non-terrestrial network, NTN, the wireless device comprising one or both of a radio interface and processing circuitry configured to cause the wireless device to:
obtain an indication to disable at least one hybrid automatic repeat request, HARQ, process and to enable at least one HARQ process; and
receive a downlink control information transmission and its corresponding physical downlink shared channel transmission for the at least one disabled HARQ process;
receive a downlink control information transmission and its corresponding physical downlink shared channel transmission for the at least one enabled HARQ process, the downlink control information transmissions for the at least one disabled HARQ process and the at least one enabled HARQ process indicating a same subframe where a HARQ-acknowledgement transmission is to be transmitted; and
transmit the HARQ-acknowledgement transmission in the indicated subframe, the HARQ-acknowledgement transmission being based on a respective HARQ-acknowledgement bit for the at least one disabled HARQ process and the at least one enabled HARQ process, an acknowledgment bit being generated as HARQ-acknowledgement bit for the enabled at least one HARQ process if the physical downlink shared channel transmission for the at least one enabled HARQ process was successfully decoded, and a non-acknowledgment bit otherwise, and an acknowledgment bit being generated as HARQ-acknowledgement bit for the disabled at least one HARQ process regardless of whether the physical downlink shared channel transmission for the at least one disabled HARQ process was successfully decoded or not.

17. The wireless device of claim 16, wherein the indication to disable at least one HARQ process and to enable at least one other HARQ process is obtained by receiving a Radio Resource Control, RRC, signaling.

18. A network node configured to communicate with a wireless device via a non-terrestrial network, NTN, the network node comprising one or both of a radio interface and processing circuitry configured to cause the network node to:
determine to disable at least one hybrid automatic repeat request, HARQ, process and to enable at least one other HARQ process;
signal an indication that is configured to disable the at least one HARQ process and to enable the at least one other HARQ process at the wireless device;
transmit a downlink control information transmission and its corresponding physical downlink shared channel transmission for the at least one disabled HARQ process;
transmit a downlink control information transmission and its corresponding physical downlink shared channel transmission for the at least one enabled HARQ process, the downlink control information transmissions for the at least one disabled HARQ process and the at least one enabled HARQ process indicating a same subframe where a HARQ-acknowledgement transmission is to be transmitted; and
receive the HARQ-acknowledgement transmission in the indicated subframe, the HARQ-acknowledgement transmission being based on a respective HARQ-acknowledgement bit for the at least one disabled HARQ process and the at least one enabled HARQ process.

19. The network node of claim 18, wherein the signaling of the indication is performed using radio resource control, RRC, signaling.

20. The wireless device of claim 16, wherein the indication to disable at least one HARQ process and to enable at least one other HARQ process is obtained by receiving the respective downlink control information transmission for the at least one disabled HARQ process and the at least one enabled HARQ process.
